(19) United States
(12) Patent Application Publication
(10) Pub. No.: US 2025/0226527 A1
(43) Pub. Date: Jul. 10, 2025

(54) BATTERY ASSEMBLY AND ASSEMBLING METHOD OF THE SAME

(71) Applicant: SK On Co., Ltd., Seoul (KR)

(72) Inventors: Dong Jun LIM, Daejeon (KR); Gang U LEE, Daejeon (KR); Won Gab HWANG, Daejeon (KR)

(21) Appl. No.: 19/010,209

(22) Filed: Jan. 6, 2025

(30) Foreign Application Priority Data
Jan. 4, 2024 (KR) 10-2024-0001609

(51) Int. Cl. H01M 50/383; H01M 50/211; H01M 50/291

(52) U.S. Cl. CPC H01M 50/383; H01M 50/211; H01M 50/291; H01M 2220/20

(57) ABSTRACT

Embodiments of the present disclosure relate to a battery assembly including a plurality of battery cells stacked and arranged in one direction, an accommodating case accommodating the plurality of battery cells, an insertion space formed between the plurality of battery cells and the accommodating case, and an insertion member including a first region tapered toward one end and positioned in the insertion space, and an assembling method of the same.

### CROSS-REFERENCE TO RELATED PATENT APPLICATION

The present application claims priority under 35 U.S.C. § 119(a) to Korean patent application number 10-2024-0001609 filed on Jan. 4, 2024, in the Korean Intellectual Property Office, the entire disclosure of which is incorporated by reference herein.

### BACKGROUND OF THE INVENTION

### 1. Field

Embodiments of the present disclosure relate to a battery assembly and an assembling method of the same. Specifically, embodiments of the present disclosure relate to a battery assembly and an assembling method of the same to delay thermal propagation (TP) during thermal runaway of a battery cell.

### 2. Description of the Related Art

Recently, due to incidents of fires or explosions occurring during the use of lithium secondary batteries, societal concerns about the safety of battery usage have been increasing. Based on these societal concerns, one of the major development tasks of lithium secondary batteries recently is to eliminate the instability, such as fires and explosions, caused by thermal runaway of battery cells.

In particular, in the battery module/battery pack, there exists empty space other than the battery cell, which serves as the energy source. If a fire occurs due to an external shock or a problem with the battery cells, flames may spread to neighboring cells through the empty space, increasing the damage caused by the fire. This risk of fire may be the biggest obstacle to the electric vehicle market, so inventions related to how to reduce the propagation of fire are constantly being researched.

### SUMMARY OF THE INVENTION

First, according to one aspect of the present disclosure, an object is to prevent or mitigate escape of high-temperature gas generated from a battery cell undergoing thermal runaway in a tab direction of the battery cell among one or more battery cells provided inside a battery assembly (e.g., a battery module or battery pack).

Second, according to another aspect of the present disclosure, an object is to vent high-temperature gas generated from a battery cell undergoing thermal runaway along an intended path.

Third, according to yet another aspect of the present disclosure, an object is to enhance the stability of the battery assembly by improving heat resistance or fire resistance.

Fourth, according to yet another aspect of the present disclosure, an object is to provide an assembling method which facilitates disposition of insertion members during assembly of the battery assembly.

The present disclosure may be widely applied in fields such as electric vehicles, battery charging stations, energy storage systems (ESS), and other green technology sectors including photovoltaics and wind power which utilize batteries. In addition, the present disclosure may be utilized in eco-friendly mobility, including electric vehicles and hybrid vehicles, to suppress air pollution and greenhouse gas emissions, thereby preventing climate change.

To achieve the aforementioned objects, a battery assembly according to the present disclosure may include: a plurality of battery cells stacked and arranged in one direction; an accommodating case accommodating the plurality of battery cells; an insertion space formed between the plurality of battery cells and the accommodating case; and an insertion member including a first region tapered toward one end and positioned in the insertion space.

In addition, the other end of the insertion member may be in a planar shape.

In addition, the insertion member may extend along a height direction of the accommodating case.

The accommodating case may include: an accommodating body forming an accommodating space to accommodate the plurality of battery cells; an accommodating cover coupled to the accommodating body to form the accommodating space together; and a bottom surface forming a bottom of the accommodating body and supporting the insertion member, wherein the first region may be positioned closer to the accommodating cover than to the bottom surface.

The bottom surface may support the other end of the insertion member.

The insertion member may further include: a second region in a cylindrical shape including the other end of the insertion member; and a body part in a cylindrical shape positioned between the first region and the second region.

In addition, a diameter of the body part may be equal to or larger than a diameter of the second region.

In addition, along an axial direction of the body part, an outer circumferential surface of the second region may be formed with a step relative to an outer circumferential surface of the body part.

The body part may include a body groove formed by recessing an outer circumferential surface of the body part along a circumferential direction of the body part perpendicular to an axial direction of the body part in a region adjacent to the second region.

In an embodiment, the first region, the body part, and the second region may be formed integrally.

In an embodiment, the insertion member may include a fire-resistant material.

In addition, each of the plurality of battery cells may include: a main body part including an electrode assembly which produces or stores electrical energy; and a lead tab part connected to the electrode assembly and protruding outward from the main body part, wherein the insertion space may be formed between respective lead tab parts of the plurality of battery cells.

A plurality of the insertion members may be provided, and the plurality of insertion members may be disposed in at least part of the insertion space between the respective lead tab parts of the plurality of battery cells.

In an embodiment, a battery assembly according to the present disclosure may further include a bus bar electrically connected to the plurality of battery cells, and the insertion space may be formed by the main body part of each of the plurality of battery cells, the lead tab part of each of the plurality of battery cells, and the bus bar.

A maximum diameter of the insertion member may be less than or equal to a distance between adjacent lead tab parts among the respective lead tab parts of the plurality of battery cells.

An assembling method of a battery assembly according to the present disclosure may include: coupling the accommodating cover to an upper part of the plurality of battery cells; a first inversion step of flipping the plurality of battery cells coupled with the accommodating cover; inserting the insertion member into the insertion space, at least partially formed by the accommodating cover and the plurality of battery cells; forming the accommodating case by coupling the accommodating body to the accommodating cover; and a second inversion step of flipping the accommodating case so that the accommodating cover faces upward.

The inserting of the insertion member into the insertion space may include inserting the insertion member into the insertion space such that a first region, including one tapered end of both ends of the insertion member, faces the accommodating cover.

The assembling method of the battery assembly according to the present disclosure may further include, prior to coupling the accommodating cover to the upper part of the plurality of battery cells, forming a cell stacking assembly by electrically connecting the plurality of battery cells and the bus bar.

First, according to an embodiment of the present disclosure, it is possible to prevent or mitigate the escape of high-temperature gas generated from a battery cell undergoing thermal runaway in a tab direction of the battery cell among one or more battery cells provided inside a battery assembly.

Second, according to another embodiment of the present disclosure, it is possible to vent high-temperature gas generated from a battery cell undergoing thermal runaway along an intended path.

Third, according to yet another embodiment of the present disclosure, it is possible to add a process of inserting an insertion member (or insertion material, a filler part) into an empty space formed between the bus bar assembly and the cell tabs of the battery to an assembling process of an existing battery assembly.

Fourth, according to yet another embodiment of the present disclosure, it is possible to enhance the stability of the battery assembly by increasing its heat resistance or fire resistance.

### BRIEF DESCRIPTION OF THE DRAWINGS

FIG. 1 is an example of a battery assembly according to the present disclosure.

FIG. 2 is an exploded view of an example of a battery assembly according to the present disclosure.

FIG. 3 is a top view of an example of a battery assembly according to the present disclosure.

FIG. 4 illustrates a part of a battery assembly according to the present disclosure.

FIG. 5 is an enlarged view illustrating a part of a battery assembly according to the present disclosure.

FIG. 6 illustrates an example of an insertion member according to the present disclosure.

FIG. 7 illustrates one side of a battery assembly according to the present disclosure.

FIG. 8 is a flowchart illustrating an example of an assembling method for a battery assembly according to the present disclosure.

FIG. 9 is another example of a battery assembly according to the present disclosure.

### DETAILED DESCRIPTION

Hereinafter, preferred embodiments of the present disclosure will be described in detail with reference to the accompanying drawings. The configurations of the devices or control methods described below are merely for describing embodiments of the present disclosure and are not intended to limit the scope of the rights of the present disclosure, and the reference numerals used consistently throughout the specification represent the same components.

In addition, a battery assembly 200 or 300 according to the present disclosure is a concept collectively referring to a battery module or a battery pack. Therefore, the battery assembly 200 or 300 according to the present disclosure may refer to not only a battery module, but also a battery packs, such as Cell to Pack (CTP), where a battery module is omitted and a plurality of battery cells are directly accommodated.

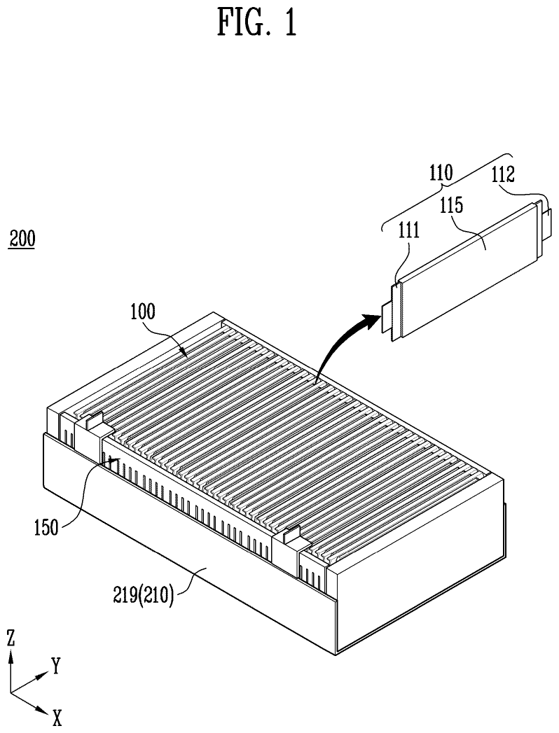

FIG. 1 is an example of the battery assembly 200 according to the present disclosure.

Referring to FIG. 1, the battery assembly 200 may include a plurality of battery cells 110 and an accommodating case 210 that accommodates the plurality of battery cells 110.

For example, each of the plurality of battery cells 110 may include a main body part 115 that produces or stores electrical energy and lead tab parts 111 and 112 that protrude outward from the main body part 115. The main body part 115 may include an electrode assembly (not shown), which includes an anode and a cathode for producing and storing electrical energy within it.

In addition, the main body part 115 may further include an electrolyte (not shown) in contact with the electrode assembly. The electrolyte may be liquid or solid. In addition, if the electrolyte is liquid, the electrode assembly may further include a separator for separating the anode and the cathode. Referring to FIG. 1, the main body part 115 may be in the form of a pouch sealed with a film-type exterior material.

Although FIG. 1 illustrates an example of a pouch-type battery cell 110, it is not limited thereto. Therefore, it may also be applied to prismatic and cylindrical battery cells.

Specifically, the lead tab parts 111 and 112 may include a first lead tab part 111 and a second lead tab part 112 that protrude from both sides of the main body part 115 in directions away from the main body part 115. This is an example, and the lead tab parts 111, 112 may be provided with both tabs on one side.

The accommodating case 210 is intended to protect the plurality of battery cells 110 from external impacts such as vibrations. The accommodating case 210 may include an accommodating body 219 that forms part of an accommodating space 280 for accommodating the plurality of battery cells 110, which will be described later.

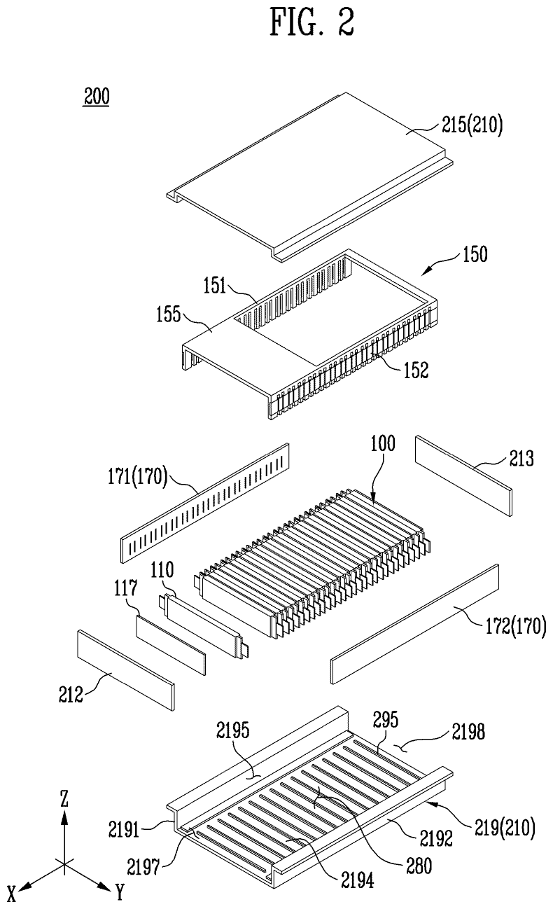

In addition, the battery assembly 200 may further include a bus bar assembly 150 that electrically connects the plurality of battery cells 110 to the outside. The bus bar assembly 150 may include a bus bar 170 (see FIG. 2) that electrically connects the plurality of battery cells 110 to output a predetermined voltage.

The bus bar assembly 150 or the form of the bus bar 170 assembled with the plurality of battery cells 110, described later, may be referred to as a cell stacking assembly 100.

FIG. 2 is an exploded view of an example of the battery assembly 200 according to the present disclosure. Referring to FIG. 2, the accommodating case 210 may include an accommodating body 219, which forms an accommodating space 280 to accommodate the plurality of battery cells 110, and an accommodating cover 215, which is coupled to the accommodating body 219 to form the accommodating space 280 together.

The plurality of battery cells 110 may be positioned overlapping along a predetermined stacking direction (e.g., an X direction) within the accommodating body 219.

More specifically, the accommodating case 210 may include an opening 2195 at an upper part, and may further include an accommodating body 219 that accommodates the plurality of battery cells 110 through the opening 2195, and the accommodating cover 215 that is coupled to the accommodating body 219 to cover the opening 2195.

Therefore, the accommodating cover 215 may be coupled to the accommodating body 219 to form an upper surface of the accommodating space 280 or an upper surface of the accommodating case 210. In other words, the accommodating cover 215 may cover the opening 2195 by coupling to the accommodating body 219, and may form the accommodating space 280 together with the accommodating body 219.

The accommodating space 280 may be formed inside the accommodating body 219 to include a space for accommodating the cell stacking assembly 100. In addition, the accommodating space 280 may further include an insertion space 288, as described later.

For example, the accommodating body 219 may be provided in the channel shape or U-shape with the upper part opening. Referring to FIG. 2, both side surfaces 2197 and 2198 of the accommodating body 219, facing each other along the X direction, may also be opened.

In other words, the accommodating body 219 may include a bottom surface 2194 that forms the bottom of the accommodating space 280, and body side surfaces 2191 and 2192 which extend from edges (not shown), which are provided parallel to each other along the stacking direction among the edges of the bottom surface 2194, towards the accommodating cover 215. The free ends of the body side surfaces 2191, 2192 may be bent to form flanges (not shown). This is for easy coupling with the accommodating cover 215.

Referring to FIG. 1 and FIG. 2, a height of the accommodating body 219 may be smaller than a height of the plurality of battery cells 110. However, this is just an example, and the height of the accommodating body 219 may be equal to or greater than the height of the plurality of battery cells 110.

The cell stacking assembly 100 may further include a thermal barrier member 117 positioned between the plurality of battery cells 110. The thermal barrier member 117 may be positioned in at least part of the spaces between the plurality of battery cells 110.

The thermal barrier member 117 may serve the role of a thermal barrier in preventing flames or heat from spreading to an adjacent other battery cell 110 during thermal runaway of one of the battery cells 110.

The cell stacking assembly 100 may include at least one of the thermal barrier member 117.

The thermal barrier member 117 may be formed as a single member to perform both the thermal barrier function and the cushioning function simultaneously. To this end, a member made of a single material may perform two functions simultaneously.

On the other hand, the thermal barrier member 117 may form a multilayer structure in which a plurality of materials are stacked along the stacking direction of the plurality of battery cells 110. In other words, one layer of the multilayer structure may include a flame-retardant material (or a fire-resistant material). In addition, the other layer of the multilayer structure may perform the role of a cushioning member to reduce the pressure exerted on other battery cells 110 during the swelling of the battery cells 110.

The plurality of battery cells 110 and the plurality of thermal barrier members 117 may be provided at predetermined positions and stacked. For example, referring to FIG. 2, an example is illustrated in which the long edges of the plurality of battery cells 110 are provided in parallel in a Y direction. Therefore, the plurality of battery cells 110 and the plurality of thermal barrier members 117 will be positioned to overlap in the X direction.

The thermal barrier members 117 may be formed of fire-resistant (heat-resistant or flame-retardant) materials. For example, the thermal barrier members 117 may include materials such as fire-resistant polymers, aerogels, or mica.

Referring to FIG. 2, the battery assembly 200 may further include end plates 212 and 213 at both ends of the cell stacking assembly 100 along the stacking direction. The end plates 212 and 213 may be provided at both ends of the cell stacking assembly 100 or formed by being connected to both side surfaces 2197 and 2198 of the accommodating body 219.

The end plates 212 and 213 are intended to prevent both side surfaces of the cell stacking assembly 100 from being exposed to the outside.

The battery assembly 200 may include the bus bar 170 electrically connected to the plurality of battery cells 110.

In addition, the battery assembly 200 may further include bus bar frames 151, 152, and 155 that support the bus bar 170 and the plurality of battery cells 110.

The bus bar frames 151, 152, and 155 may be electrically connected to the outside to store (or charge) electrical energy in the plurality of battery cells 110 or supply (or discharge) the electrical energy stored in the plurality of battery cells 110 to the outside.

The bus bar assembly 150 may include a first bus bar frame 151 and a second bus bar frame 152, which extend along the stacking direction of the plurality of battery cells 110, with the plurality of battery cells 110 interposed between them.

In addition, the bus bar assembly 150 may further include a support frame 155 positioned on one side of the bus bar assembly 150 to connect the first bus bar frame 151 and the second bus bar frame 152.

The bus bar assembly 150 is described by using a case where the lead tab parts 111, 112 are respectively positioned on opposite sides of the main body part 115. On the other hand, in case that the lead tab parts 111, 112 are located on one side of the main body part 115 and face the same direction, the bus bar frames 151, 152 may be positioned on one side of the main body part 115, for example, on an upper part of the main body part 115, and electrically connected to the lead tab parts 111, 112.

The support frame 155 may perform the role of preventing and supporting deformation of the first bus bar frame 151 and the second bus bar frame 152. In addition, a part of an electrical device for sensing and controlling the plurality of battery cells 110 may be disposed on the support frame 155.

Referring to FIG. 2, the shape of the bus bar assembly 150 may be a tunnel shape. Further, the length of the first bus bar frame 151 and the second bus bar frame 152 along the stacking direction may be longer than the length of the support frame 155.

In other words, the support frame 155 may be connected to the first bus bar frame 151 and the second bus bar frame 152 to cover an upper part of the plurality of battery cells 110. In other words, the support frame 155 may cover not only a portion of the upper part of the plurality of battery cells 110 but may cover the entire upper part.

Referring to FIG. 2, the bus bar 170 may include a first bus bar 171, which is supported by the first bus bar frame 151 and electrically connected to the first lead tab part 111, and a second bus bar 172, which is supported by the second bus bar frame 152 and electrically connected to the second lead tab part 112.

The first bus bar 171 and the second bus bar 172 may be positioned in directions farther from the plurality of battery cells 110 than the first bus bar frame 151 and the second bus bar frame 152, respectively. In other words, they may be positioned closer to the body side surfaces 2191, 2192 than the first bus bar frame 151 and the second bus bar frame 152. Therefore, the first lead tab part 111 and the second lead tab part 112 may be inserted into slit holes (not shown) formed in the first bus bar frame 151 and the second bus bar frame 152, respectively, to be electrically connected to the first bus bar 171 and the second bus bar 172. However, this is only an example, and the first lead tab part 111 and the second lead tab part 112 may respectively be electrically connected to the first bus bar 171 and the second bus bar 172 in other ways.

The battery assembly 200 may further include a heat dissipation part 295 positioned between the bottom surface 2194 and the plurality of battery cells 110 to transfer heat generated by the plurality of battery cells 110 to the outside of the battery assembly 200. The heat dissipation part 295 may be provided as a heat-conductive adhesive material, such as a thermal adhesive. Therefore, the heat dissipation part 295 may adhere the plurality of battery cells 110 to the bottom surface 2194. To this end, the heat dissipation part 295 may be sprayed or applied onto the bottom surface 2194.

Referring to FIG. 2, the bus bar assembly 150 may include a first bus bar 171 electrically connected to the first lead tab part 111 and a first bus bar frame 151 supporting the first bus bar 171. The first bus bar 171 and the first bus bar frame 151 may collectively be referred to as the first bus bar assembly. In other words, the first bus bar assembly is electrically connected to the first lead tab part 111 and may perform the role of supporting the cell stacking assembly 100.

The bus bar assembly 150 may further include a second bus bar 172 electrically connected to the second lead tab part 112 and a second bus bar frame 152 supporting the second bus bar 172. The second bus bar 172 and the second bus bar frame 152 may collectively be referred to as the second bus bar assembly. In other words, the second bus bar assembly is electrically connected to the second lead tab part 112 and, together with the first bus bar assembly, may perform the role of supporting the cell stacking assembly 100.

The battery group BG refers to a set of battery cells, where adjacent battery cells 110 are grouped in a predetermined group number among the plurality of battery cells 110. The plurality of battery cells 110 may group the plurality of battery cells 110 in the predetermined group number for a predetermined target voltage or target current, and then may connect the battery groups BG in series or in parallel using the bus bar 170.

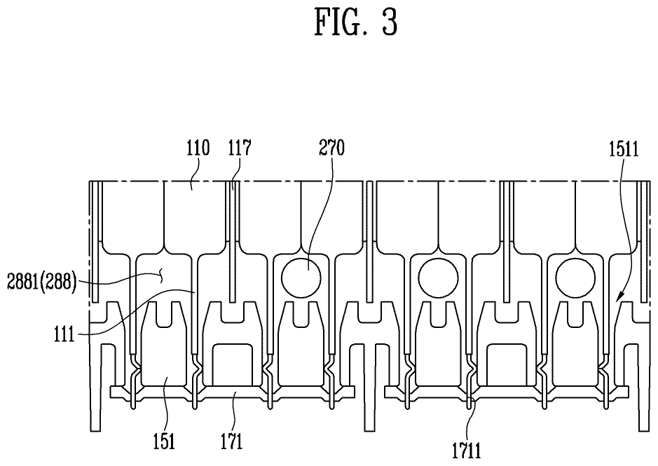

FIG. 3 is a top view of an example of the battery assembly 200 according to the present disclosure.

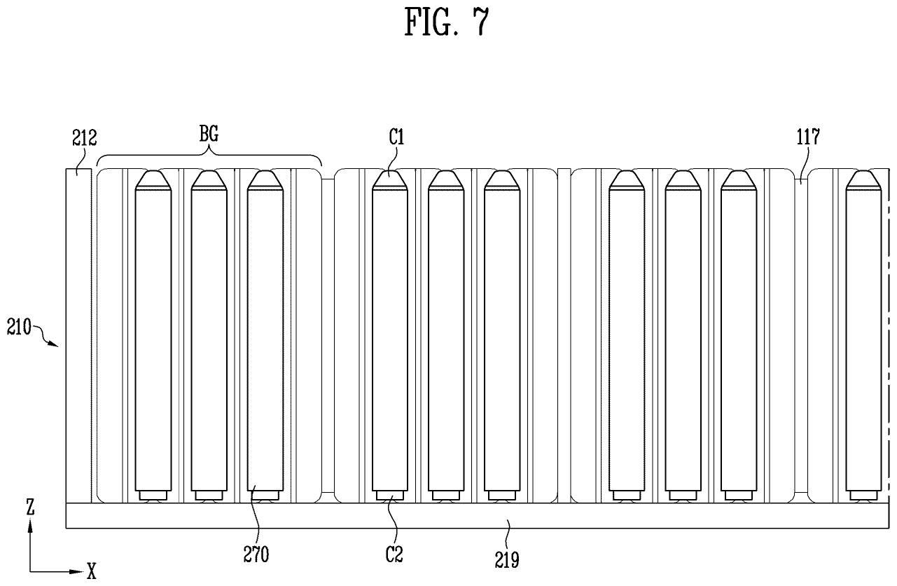

Referring to FIG. 3, the thermal barrier member 117 may be positioned between the plurality of battery cells 110. On the other hand, the thermal barrier member 117 may be positioned between battery groups BG (see FIG. 7), which are formed by grouping adjacent battery cells 110 into a predetermined group number.

Along the direction from the first bus bar 171 toward the second bus bar 172 (see FIG. 2), the length of the thermal barrier member 117 may be longer than the length of the main body part 115. More specifically, the thermal barrier member 117 may contact the first bus bar frame 151 and the second bus bar frame 152. Through this, the thermal barrier member 117 may block or delay the spread of heat or flames to other areas during the thermal runaway of any battery cell 110.

Referring to FIG. 3, the first bus bar 171 may include an insertion hole 1711 formed by penetrating the first bus bar 171 to electrically connect the first lead tab part 111 (see FIG. 1) to the first bus bar 171.

The first bus bar frame 151 may be positioned between the main body part 115 (see FIG. 1) and the first bus bar 171 to support the first bus bar 171. Therefore, the first bus bar frame 151 may include a through-hole 1711 through which the first lead tab part 111 passes.

In addition, referring to FIG. 3, due to the electrical connection between the first lead tab part 111 and the first bus bar 171, an empty space (hereinafter referred to as an insertion space 288) may be formed between the plurality of battery cells 110 and the bus bar assembly 150.

Similarly, although not shown in FIG. 3, referring to FIGS. 2 and 3, to electrically connect the second lead tab part 112 (see FIG. 1) to the second bus bar 172, the second bus bar 172 may include another insertion hole formed by penetrating the second bus bar 172.

The second bus bar frame 152 may be positioned between the main body part 115 (see FIG. 1) and the second bus bar 172 to support the second bus bar 172. Therefore, the second bus bar frame 152 may include another through-hole through which the second lead tab part 112 passes.

Therefore, similar to an insertion space (or a first insertion space) formed between the main body part 115, the first lead tab part 111, and the first bus bar 171, an insertion space (or a second insertion space) may be formed between the main body part 115, the second lead tab part 112, and the second bus bar 172.

In other words, a portion of the accommodating space 280 (see FIG. 2) formed inside the accommodating case 210 (see FIG. 2) may be a space for accommodating the plurality of battery cells 110, and another portion of the accommodating space 280 may be a space for the insertion space 288.

Specifically, the insertion space 288 is a space formed by each main body part 115, each of the lead tab parts 111, 112, and the bus bar 170 (see FIG. 2). In general, if thermal runaway occurs in one of the plurality of battery cells 110 and off-gas is generated, high-temperature heat may propagate to adjacent other battery cells through the insertion space 288. To prevent such heat propagation, it is necessary to fill or seal the insertion space 288.

To this end, the battery assembly 200 according to the present disclosure may include an insertion member 270 inserted into and positioned in the insertion space 288.

In other words, the battery assembly 200 according to the present disclosure may include a plurality of battery cells 110 stacked and arranged in a predetermined stacking direction, an accommodating case 210 accommodating the plurality of battery cells 110, an insertion space 288 formed between the plurality of battery cells 110 and the accommodating case 210 along the stacking direction, and an insertion member 270 positioned in the insertion space 288.

More specifically, the insertion space 288 may include a first insertion space 2881 and a second insertion space (not shown). The second insertion space is identical in function and form to the first insertion space 2881, differing only in the position where it is formed.

In addition, the plurality of first insertion spaces 2881 may be formed by the first lead tab parts 111, and the plurality of first insertion spaces 2881 may communicate with each other.

Similarly, referring to FIGS. 2 and 3, a plurality of second insertion spaces (not shown) may be formed at positions different from the first insertion spaces 2881 by the second lead tab parts 112, and the plurality of second insertion spaces (not shown) may communicate with each other. And a plurality of the insertion members 270 may be provided, and the plurality of the insertion members 270 are disposed in at least part of the insertion spaces 288 between the respective lead tab parts 111, 112 of the plurality of battery cells 110.

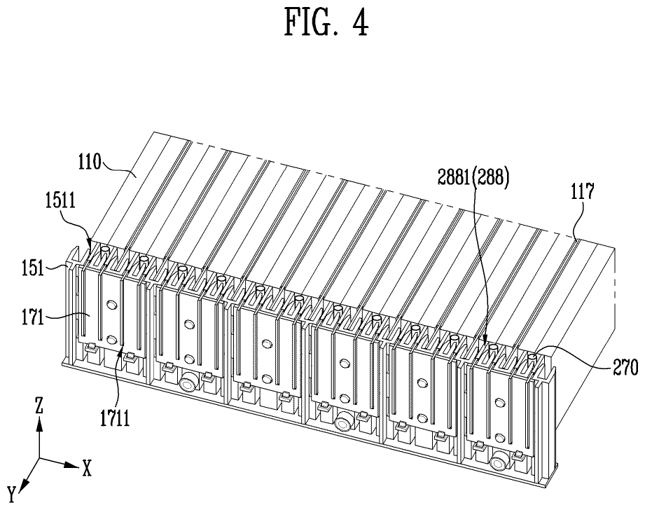

FIG. 4 illustrates a part of the battery assembly 200 according to the present disclosure.

Referring to FIG. 4, the battery assembly 200 may further include a thermal barrier member 117 positioned between the plurality of battery cells 110. In addition, the battery assembly 200 may further include a thermal barrier member 117 positioned between battery groups BG formed by grouping the plurality of battery cells 110.

Referring to FIGS. 3 and 4, the thermal barrier member 117 may be provided parallel to the plurality of battery cells 110 and may be extended to the bus bar assembly 150. More specifically, the thermal barrier member 117 may be extended to the bus bar frames 151, 152 and may be inserted into the bus bar frames 151, 152. In this case, the insertion member 270 may not be inserted into the space where the thermal barrier member 117 is inserted. This is to prevent interference between the insertion member 270 and the thermal barrier member 117.

The first insertion space 2881 may be divided by the first lead tab part 111. Similarly, the second insertion space (not shown) may be divided by the second lead tab part 112 (see FIG. 1).

Referring to FIGS. 3 and 4, the first lead tab part 111 may be inserted into the through-hole 1511 and the insertion hole 1711.

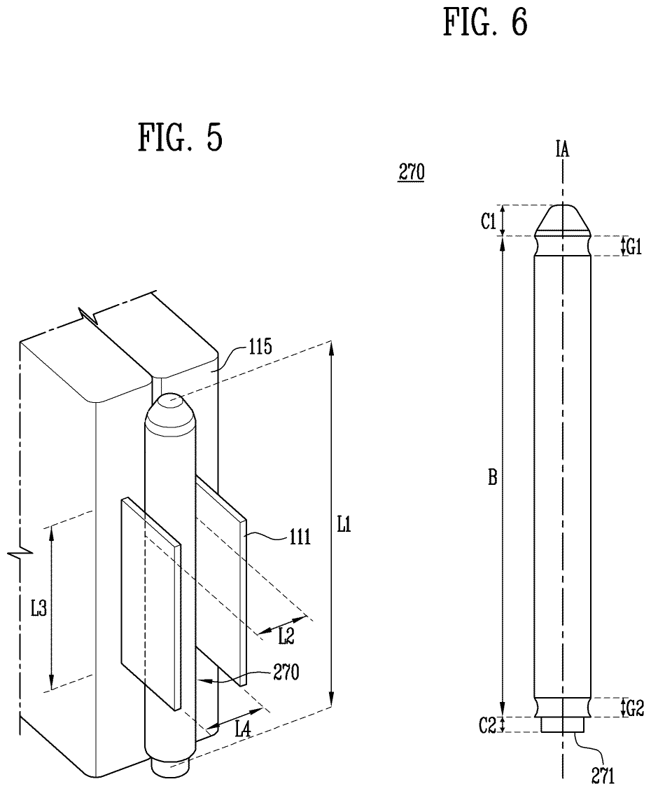

FIG. 5 is an enlarged view illustrating a part of the battery assembly 200 according to the present disclosure.

As described above, the insertion space 288 may be formed between the plurality of battery cells 110 and the bus bar assembly 150 (or the bus bar 170). The insertion space 288 may be formed as each of the lead tab parts 111 and 112 is connected to the bus bar 170.

The insertion space 288 may include a plurality of divided spaces 2889 separated by the respective lead tab parts 111, 112. However, the respective lead tab parts 111, 112 do not individually separate the plurality of divided spaces 2889 in an isolated manner. In other words, along the height direction of the accommodating case 210, the length L3 of the respective lead tab parts 111, 112 is smaller than the height of the accommodating space 280, so it at least partially divides along the height of the accommodating space 280.

In other words, since the length L3 of the respective lead tab parts 111, 112 along the height direction of the accommodating case 210 is smaller than the length of the respective main body part 115, the plurality of insertion spaces 288 may be divided by the respective lead tab parts 111, 112 and may also communicate with each other.

More specifically, the plurality of first insertion spaces 2881 may be formed by the first lead tab part 111, and the plurality of first insertion spaces 2881 may communicate with each other.

Similarly, referring to FIGS. 2 and 3, a plurality of second insertion spaces (not shown) may be formed in positions different from the first insertion spaces 2881 by the second lead tab part 112, and the plurality of second insertion spaces may communicate with each other.

In addition, the length L1 of the insertion member 270 along the height direction of the accommodating case 210 may be greater than the length L3 of the respective lead tab parts 111, 112.

And, preferably, the maximum diameter L2 of the insertion member 270 along the stacking direction may be equal to or smaller than the space L4 between the two adjacent lead tab parts 111, 112.

FIG. 6 illustrates an example of an insertion member 270 according to the present disclosure.

The insertion member 270 may be positioned in the insertion space 288 (see FIG. 4) to delay the propagation of flames or heat through the insertion space 288 to adjacent other battery cells 110 during thermal runaway of any one of the battery cells 110 (see FIG. 1). If the insertion space 288 is empty, it may become a passage for the propagation of flames or high-temperature gases. Therefore, to effectively minimize or prevent this, it is desirable to insert the insertion member 270 into the insertion space 288.

In addition, the insertion member 270 may include a fire-resistant material (or flame-retardant material) to minimize the propagation of flames or high-temperature gases.

Therefore, the melting point of the insertion member 270 may be higher than the ignition point of the plurality of battery cells 110. The ignition point of the plurality of battery cells 110 may be higher than the temperature at which venting occurs in the battery cells 110. Alternatively, the melting point of the insertion member 270 may be higher than the temperature of the electrolyte accommodated inside the battery cell 110 (or inside the main body part 115, see FIG. 1) when the external case (or accommodating case) of the battery cell 110 is torn or opened during a thermal runaway event.

When thermal runaway begins in any one of the battery cells 110, the external case may tear or open, releasing high-temperature gas or flames from inside the battery cell 110. Even so, the insertion member 270 may retain its original shape.

As described above, even if thermal runaway occurs in the battery cell 110, the insertion member 270 may neither burn nor melt, and the external shape of the insertion member 270 may remain unchanged with no significant deformation. In addition, through this, the insertion member 270 may delay the thermal propagation time of propagating the thermal runaway from one battery cell 110 to adjacent other battery cells 110.

The insertion member 270 may be formed of a porous material. A porous material refers to a material including pores in its structure. The shape of the pores may be irregular and amorphous. Preferably, the porosity of the insertion member 270 may be 20 percent (%) or more and 30 percent (%) or less.

In addition, the fire-resistant material may be an inorganic compound. In other words, the insertion member 270 may include a fire-resistant material formed from an inorganic compound. The inorganic compound may be selected from the group including Alum (K₂SO₄·Al₂(SO₄)₃·24H₂O), Borax (Na₂B₄O₇·10H₂O), Lime Water (Ca(OH)₂ Aqueous Solution), Quicklime (CaO), Milk of Lime (White Emulsion made by mixing Ca(OH)₂ with water), Slaked Lime (Ca(OH)₂), Washing Soda (Na₂CO₃·10H₂O), Apatite (Ca₅(PO₄)₃OH), Baking Powder (a mixture of NaHCO₃ and salts of tartaric acid), Baking Soda (NaHCO₃), Sodium Thiosulfate Pentahydrate (Na₂S₂O₃·5H₂O), Silica (or Silicon Dioxide (SiO₂)), Alumina (Alumina or Aluminum Oxide (Al₂O₃)), Calcium Oxide (CaO), Calcium Sulfate (CaSO₄), Calcium Chloride (CaCl₂), Sodium Carbonate (Na₂CO₃), Potassium Chloride (KCl), Magnesium Oxide (MgO), Zirconium Oxide (ZrO₂), Chromium Oxide (Cr₂O₃), Aluminum Hydroxide (Al(OH)₃), Antimony Trioxide (Sb₂O₃), Antimony Pentoxide (Sb₂O₅), Magnesium Hydroxide (Mg(OH)₂) and Zinc Borate compounds, Phosphorus-based compounds, Nitrogen-based Guanidine compounds, Molybdenum compounds, or mixtures thereof.

The insertion member 270 may also include a fire-resistant material such as silica gel, alumina gel, or aerogel. In other words, the insertion member 270 may include silicon dioxide (SiO₂).

Preferably, the silica gel may contain 90 percent (%) or more silicon dioxide. In addition, since the silica gel is a porous material, the porosity of the insertion member 270 may be 20 percent (%) or more and 30 percent (%) or less.

In addition, the insertion member 270 may be formed of aerogel. This is because aerogel not only has low thermal conductivity but also absorbs moisture and expands in high-humidity environments.

For example, the insertion member 270 may be formed of materials other than silica gel as long as they have porous and flame-retardant (heat-resistant or fire-resistant) properties. In addition, the insertion member 270 may not be formed of a single material but may include multiple fire-resistant materials.

In another example, the insertion member 270 may refer to a polymer material with a V-0 rating in 94V test (Vertical Burning Test) of Underwriter's Laboratory (UL), which is the flame-retardant standard for polymer materials.

Specifically, the insertion member 270 may include a flame-retardant polymer. The flame-retardant material may include phosphorus-based, halogen-based, or inorganic flame retardants, and preferably, in the case of phosphorus-based flame-retardant materials, it may include phosphate compounds, phosphonate compounds, phosphinate compounds, phosphine oxide compounds, phosphazene compounds, metal salts thereof, and so on. These may be used alone or in combinations of two or more.

In another specific embodiment, the phosphorus-based flame retardant may include diphenyl phosphate, diaryl phosphate, triphenyl phosphate, tricresyl phosphate, trixylenyl phosphate, tri(2,6-dimethylphenyl) phosphate, tri(2,4,6-trimethylphenyl) phosphate, tri(2,4-ditert-butylphenyl) phosphate, tri(2,6-dimethylphenyl) phosphate, bisphenol-A bis(diphenyl phosphate), resorcinol bis(diphenyl phosphate), resorcinol bis[bis(2,6-dimethylphenyl) phosphate], resorcinol bis[bis(2,4-ditert-butylphenyl) phosphate], hydroquinone bis[bis(2,6-dimethylphenyl) phosphate], hydroquinone bis[bis(2,4-ditert-butylphenyl) phosphate], oligomeric phosphate ester compounds, and the like, but is not limited thereto. These may be applied alone or in the form of a mixture of two or more.

For example, the insertion member 270 may be provided in a cylindrical shape.

Referring to FIG. 6, the insertion member 270 may include a body part B in a cylindrical shape, a first region C1 extending along the axial direction IA of the body part B from one end of the body part B, and a second region C2 extending in the opposite direction to the first region C1 along the axial direction IA of the body part B from the other end of the body part B. The first region C1, the body part B, and the second region C2 may be formed integrally. Additionally A diameter of the body part B may be equal to or larger than a diameter of the second region C2.

The first region C1 may be a region including one end of the insertion member 270, and the second region C2 may be a region including the other end 271 of the insertion member 270.

The first region C1 is tapered to facilitate the insertion of the insertion member 270 into the insertion space 288. In other words, the first region C1 may serve as a guide to allow insertion into the space between the lead tab parts 111, 112.

The other end 271 of the insertion member 270 may be provided in a planar shape, unlike the one end of the insertion member 270. This is so that it is supported perpendicular to the bottom surface 2194. If the other end of the insertion member 270 is a tapered shape, it is inclined toward the adjacent lead tab parts 111, 112, and may physically bring about the deformation of the lead tab parts 111, 112. In other words, a plurality of the insertion members 270 may be provided, and the plurality of insertion members 270 are disposed in at least part of the insertion space 288 between the respective lead tab parts 111, 112 of the plurality of battery cells 110.

In addition, since the volume of the insertion member 270 provided in a planar shape at one end is larger than that of the insertion member tapered at both ends, the volume of the insertion space 288 may be filled more, so that the delay effect of thermal propagation may be improved.

The body part B may form body grooves G1 and G2 recessed along the outer circumferential surface of the body part B in areas connecting to the first region C1 or the second region C2. This is to reduce interference between the insertion member 270 and the lead tab parts 111, 112 during assembly. Along an axial direction of the body part B, an outer circumferential surface of the second region C2 may be formed with a step relative to an outer circumferential surface of the body part B.

FIG. 7 illustrates one side of the battery assembly 200 according to the present disclosure. Referring to FIG. 7, the first region C1 may be positioned at the upper part of the accommodating case 210 along the height direction of the accommodating case 210, and the second region C2 may be positioned at a lower part of the accommodating case 210.

More specifically, the first region C1 may be positioned closer to the accommodating cover 215 (see FIG. 2) or the opening 2195 (see FIG. 2) than to the bottom surface 2194 (see FIG. 2). The second region C2 may be positioned closer to the bottom surface 2194 (see FIG. 2) than to the accommodating cover 215 (see FIG. 2).

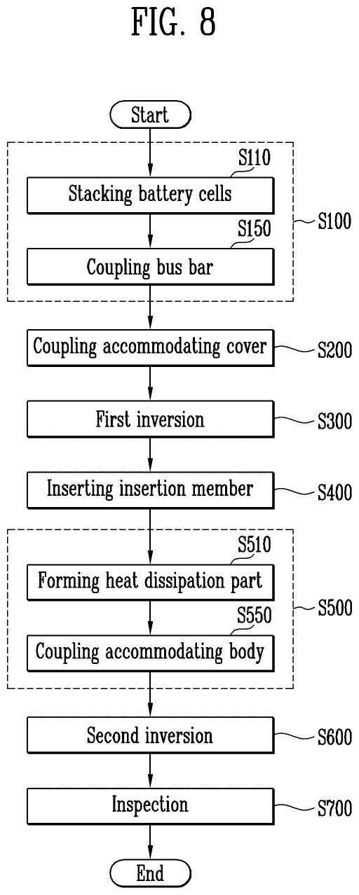

FIG. 8 is a flowchart illustrating an example of an assembling method of the battery assembly 200 according to the present disclosure.

Referring to FIG. 8, an assembling method of the battery assembly 200 according to the present disclosure may include coupling the accommodating cover 215 to an upper part of the plurality of battery cells 110 (S200), a first inversion step of flipping the plurality of battery cells 110 coupled with the accommodating cover 215 (S300), inserting the insertion member 270 into the insertion space 288, which is at least partially formed by the accommodating cover 215 and the plurality of battery cells 110 (S400), forming the accommodating case 210 by coupling the accommodating body 219 to the accommodating cover 215 (S500), and a second inversion step of flipping the accommodating case 210 so that the accommodating cover 215 faces upward (S600).

Thereafter, the assembling method of the battery assembly 200 according to the present disclosure may further include inspecting to check whether the assembly has been properly completed (S700).

In addition, the assembling method of the battery assembly 200 according to the present disclosure may perform, prior to coupling the accommodating cover 215 to the upper part of the plurality of battery cells 110 (S200), forming the cell stacking assembly 100 (S100). Forming the cell stacking assembly 100 (S100) may include stacking the plurality of battery cells 110 in a predetermined stacking direction (S110), and electrically connecting (or coupling) the stacked plurality of battery cells 110 with the bus bar 170 (S150).

The assembling method of the battery assembly 200 according to the present disclosure, in coupling the accommodating cover 215 to the upper part of the plurality of battery cells 110 (S200), will couple the accommodating cover 215 to an upper part of the cell stacking assembly 100.

By coupling the plurality of battery cells 110 or the cell stacking assembly 100 to the accommodating cover 215, at least a part of the insertion space 288 may be formed.

Thereafter, the assembling method of the battery assembly 200 according to the present disclosure may perform the first inversion step of flipping the plurality of battery cells 110 coupled to the accommodating cover 215 (S300). Through the first inversion step (S300), the accommodating cover 215 goes down and the insertion space 288 is positioned upward, allowing the insertion member 270 to be moved from the upper part to the lower part and inserted into the insertion space 288. Alternatively, the insertion member 270 may be moved toward the accommodating cover 215 to be inserted into the insertion space 288.

At this time, the assembling method of the battery assembly 200 according to the present disclosure may insert the insertion member 270 into the insertion space 288 so that the first region C1, which includes the tapered one end of both ends of the insertion member, faces the accommodating cover 215.

In other words, because the accommodating cover 215 is disposed at the bottom through the first inversion step (S300), the insertion member 270 will be inserted into the insertion space 288 by moving it toward the accommodating cover 215 with the first region C1 facing downward. Thus, when the insertion member 270 is inserted, the tapered first region C1 will facilitate the insertion of the insertion space 288.

Thereafter, the assembling method of the battery assembly 200 according to the present disclosure may perform forming the accommodating case 210 by coupling the accommodating body 219 to the accommodating cover 215 (S500).

Forming the accommodating case 210 by coupling the accommodating body 219 to the accommodating cover 215 (S500) may include forming a heat dissipation part 295 on the bottom surface 2194 (S510) and coupling the accommodating body 219 to the accommodating cover 215 (S550).

In particular, in coupling the accommodating body 219 to the accommodating cover 215 (S550), the opening 2195 of the accommodating body 219 will be flipped to face the accommodating cover 215 and then coupled to the accommodating cover 215. Therefore, the battery assembly 200 is flipped with the accommodating cover 215 disposed at the bottom.

To dispose the accommodating cover 215 upward, the assembling method of the battery assembly 200 according to the present disclosure may perform the second inversion step of flipping the accommodating case 210 so that the accommodating cover 215 faces upward (S600). Through the second inversion step (S600), the first region C1 will face upward again.

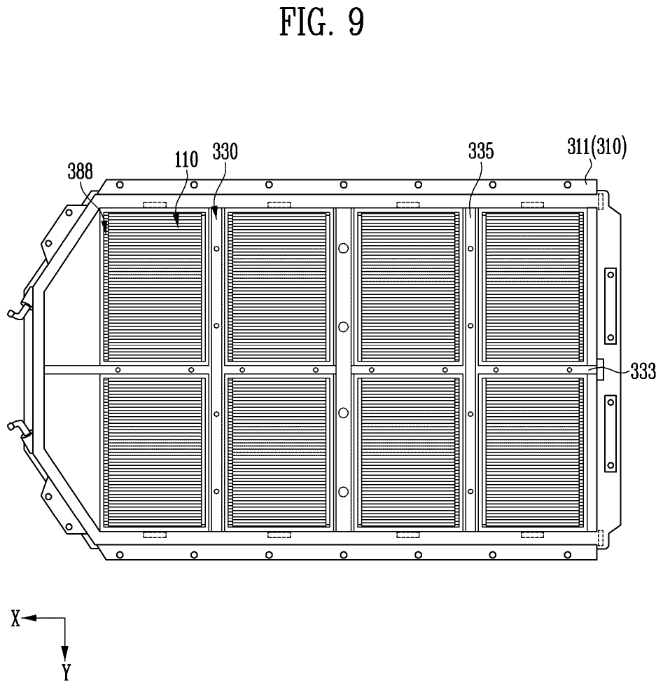

FIG. 9 is another example of the battery assembly 300 according to the present disclosure.

The aforementioned battery assembly 200 has been described based on the battery module, but FIG. 11 illustrates another example of the battery assembly 300 provided in the form of a battery pack. In an embodiment, the battery assembly 300 may also be the form of a CTP (Cell to Pack) structure, where the plurality of battery cells 110 are directly accommodated in the pack without a battery module.

The battery assembly 300 may include a plurality of battery cells 110 stacked and arranged in a predetermined stacking direction, an accommodating case 310 accommodating the plurality of battery cells, an insertion space 388 formed along the stacking direction between the plurality of battery cells 110 and the accommodating case, and an insertion member 270 (see FIG. 6) positioned in the insertion space 388.

The accommodating case 310 may include an accommodating body 311 accommodating the plurality of battery cells 110 and an accommodating cover (not shown) coupled to the accommodating body 311. In addition, the accommodating case 310 may further include partition parts 330 that divide the space where the plurality of battery cells 110 are positioned.

Therefore, the insertion space 388 may be formed between the plurality of battery cells 110 and the partition parts 330 or between the plurality of battery cells 110 and the accommodating case 310.

The partition parts 330 may further include a first frame 333 and a second frame 335, which respectively divide the plurality of battery cells 110 horizontally and vertically. The first frame 333 and the second frame 335 are not only to prevent deformation of the accommodating body 311 but also to support and separate the plurality of battery cells 110.

The present disclosure may be implemented by being modified in various forms, and the scope of the rights is not limited to the aforementioned embodiments. Therefore, if a modified embodiment includes the elements of the appended claims of the present disclosure, it should be considered to fall within the scope of the rights of the present disclosure.

What is claimed is:

1. A battery assembly comprising:
a plurality of battery cells stacked and arranged in one direction;
an accommodating case accommodating the plurality of battery cells;
an insertion space formed between the plurality of battery cells and the accommodating case; and
an insertion member comprising a first region tapered toward one end and positioned in the insertion space.

2. The battery assembly according to claim 1, wherein the other end of the insertion member is in a planar shape.

3. The battery assembly according to claim 1, wherein the insertion member extends along a height direction of the accommodating case.

4. The battery assembly according to claim 1, wherein the accommodating case comprises:
an accommodating body forming an accommodating space to accommodate the plurality of battery cells;
an accommodating cover coupled to the accommodating body to form the accommodating space together; and
a bottom surface forming a bottom of the accommodating body and supporting the insertion member, and
the first region is positioned closer to the accommodating cover than to the bottom surface.

5. The battery assembly according to claim 4, wherein the bottom surface supports the other end of the insertion member.

6. The battery assembly according to claim 1, wherein the insertion member further comprises:
a second region in a cylindrical shape comprising the other end of the insertion member; and
a body part in a cylindrical shape positioned between the first region and the second region.

7. The battery assembly according to claim 6, wherein a diameter of the body part is equal to or larger than a diameter of the second region.

8. The battery assembly according to claim 6, wherein, along an axial direction of the body part, an outer circumferential surface of the second region is formed with a step relative to an outer circumferential surface of the body part.

9. The battery assembly according to claim 6, wherein the body part comprises a body groove formed by recessing an outer circumferential surface of the body part along a circumferential direction of the body part perpendicular to an axial direction of the body part in a region adjacent to the second region.

10. The battery assembly according to claim 6, wherein the first region, the body part, and the second region are formed integrally.

11. The battery assembly according to claim 1, wherein the insertion member comprises a fire-resistant material.

12. The battery assembly according to claim 1, wherein each of the plurality of battery cells comprises:
a main body part comprising an electrode assembly which produces or stores electrical energy; and
a lead tab part connected to the electrode assembly and protruding outward from the main body part, and
the insertion space is formed between respective lead tab parts of the plurality of battery cells.

13. The battery assembly according to claim 12, wherein a plurality of the insertion members are provided, and
the plurality of insertion members are disposed in at least part of the insertion space between the respective lead tab parts of the plurality of battery cells.

14. The battery assembly according to claim 12 further comprising:
a bus bar electrically connected to the plurality of battery cells,
wherein the insertion space is formed by the main body part of each of the plurality of battery cells, the lead tab part of each of the plurality of battery cells, and the bus bar.

15. The battery assembly according to claim 12, wherein a maximum diameter of the insertion member is less than or equal to a distance between adjacent lead tab parts among the respective lead tab parts of the plurality of battery cells.

16. An assembling method of a battery assembly, which comprises: a plurality of battery cells; an accommodating case comprising an accommodating body and an accommodating cover to form together an accommodating space accommodating the plurality of battery cells; an insertion space formed by the plurality of battery cells, the accommodating body, and the accommodating cover; and an insertion member which is inserted into the insertion space, the assembling method comprising:
coupling the accommodating cover to an upper part of the plurality of battery cells;
a first inversion step of flipping the plurality of battery cells coupled with the accommodating cover;
inserting the insertion member into the insertion space, at least partially formed by the accommodating cover and the plurality of battery cells;
forming the accommodating case by coupling the accommodating body to the accommodating cover; and
a second inversion step of flipping the accommodating case so that the accommodating cover faces upward.

17. The assembling method according to claim 16, wherein the inserting of the insertion member into the insertion space comprises inserting the insertion member into the insertion space such that a first region, comprising one tapered end of both ends of the insertion member, faces the accommodating cover.

18. The assembling method according to claim 16, further comprising, prior to coupling the accommodating cover to the upper part of the plurality of battery cells, forming a cell stacking assembly by electrically connecting the plurality of battery cells and a bus bar.
